(19) United States
(12) Patent Application Publication
(10) Pub. No.: US 2016/0112838 A1
(43) Pub. Date: Apr. 21, 2016

(54) BEACONS TO ADVERTISE PRESENCE OF NEARBY OBJECTS TO STATIONS IN A WIRELESS COMMUNICATION NETWORK

(71) Applicant: Meru Networks, Sunnyvale, CA (US)

(72) Inventors: Anil KAUSHIK, Bangalore (IN); Saurabh BHARGAVA, San Jose, CA (US)

(73) Assignee: MERU NETWORKS, Sunnyvale, CA (US)

(21) Appl. No.: 14/515,527

(22) Filed: Oct. 16, 2014

(51) Int. Cl. H04W 4/02; H04W 40/24; H04W 64/00

(52) U.S. Cl. CPC H04W 4/023; H04W 64/003; H04W 40/244

(57) ABSTRACT

Beacons (e.g., mBeacons or meruBeacons) to advertise presence of nearby objects to stations in a wireless communication network from an access point are provided. Location of a station connected to the access point is detected. One or more physical objects having a location proximate to the station are identified and can be indicated to a user. To do so, in an embodiment, responsive to the proximity of locations, a beacon having a BSSID corresponding to each of the one or more physical objects is generated. The BSSID can uniquely identify the one or more physical objects. The beacon is transmitted the station which can request additional information concerning the one or more physical objects. For example, an Amazon listing for a nearby retail item can be automatically displayed on a smartphone.

### FIELD OF THE INVENTION

The invention relates generally to wireless computer networking, and more specifically, advertising the presence of nearby objects to stations utilizing modified beacons for wireless communication.

### BACKGROUND

Everyday objects embedded with tags are a rapidly expanding part of devices tracked on the Internet. The so-called IoT (Internet of Things) assigns IP addresses to objects such as thermostats and televisions that are not primarily computing devices, but now have embedded or added networking capabilities. Additionally, many objects are embedded with passive RFID tags, NFC tags or QR codes.

However, each of the current implementations of IoT involves embedding or retrofitting the device with additional computing circuitry. This approach can be limiting in time and cost. Further, embedding or retrofitting is not always feasible or desirable, such as a fish or an antique.

What is needed is a robust technique to modify Wi-Fi or other types of beacons to advertise a presence of nearby objects to stations without embedded or retrofitted computer circuitry.

### SUMMARY

These shortcomings are addressed by the present disclosure of methods, computer program products, and systems for advertising a presence of nearby objects to stations utilizing modified beacons.

In one embodiment, a location of a station connected to the access point is detected. One or more physical objects having a location proximate to the station are identified and can be indicated to a user. To do so, in an embodiment, responsive to the proximity of locations, a beacon having a BSSID (Basic Service Set Identification) corresponding to each of the one or more physical objects is generated. The BSSID can uniquely identify the one or more physical objects. The beacon is transmitted the station which can request additional information concerning the one or more physical objects. For example, an Amazon listing for a nearby retail item can be automatically displayed on a smartphone.

Advantageously, information about nearby objects is provided to wireless devices without embedding or retrofitting the objects with computer circuitry.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system to advertise the presence of nearby physical objects within wireless beacons, according to one embodiment.

FIG. 2 is a more detailed block diagram illustrating an access point of the system of FIG. 1, according to one embodiment.

FIG. 3 is a more detailed block diagram illustrating a controller of the system of FIG. 1, according to one embodiment.

FIG. 4 is a sequence diagram illustrating interactions between components of the system of FIG. 1, according to one embodiment.

FIG. 5 is a flow diagram illustrating a method, in an access point, for advertising the presence of nearby physical objects within wireless beacons, according to one embodiment.

FIG. 6 is a flow diagram illustrating a block diagram illustrating an beacon format for aggregate BSSIDs, according to one embodiment.

FIG. 7 is a block diagram illustrating an exemplary computing device, according to one embodiment.

### DETAILED DESCRIPTION

The present invention provides methods, computer program products, and systems for advertising a presence of nearby physical objects to stations utilizing modified beacons in a wireless communication network. The physical objects can be any real-world object, with or without computing and networking capabilities. Using unique identifiers associated with advertisements, additional information about physical objects can be retrieved from the network. For example, a make and model of a television or a current program can be provided, a year and ingredient list for nearby wines can be provided, or a title and price of a nearby book can be provided. One of ordinary skill in the art will recognize that many other scenarios are possible, as discussed in more detail below.

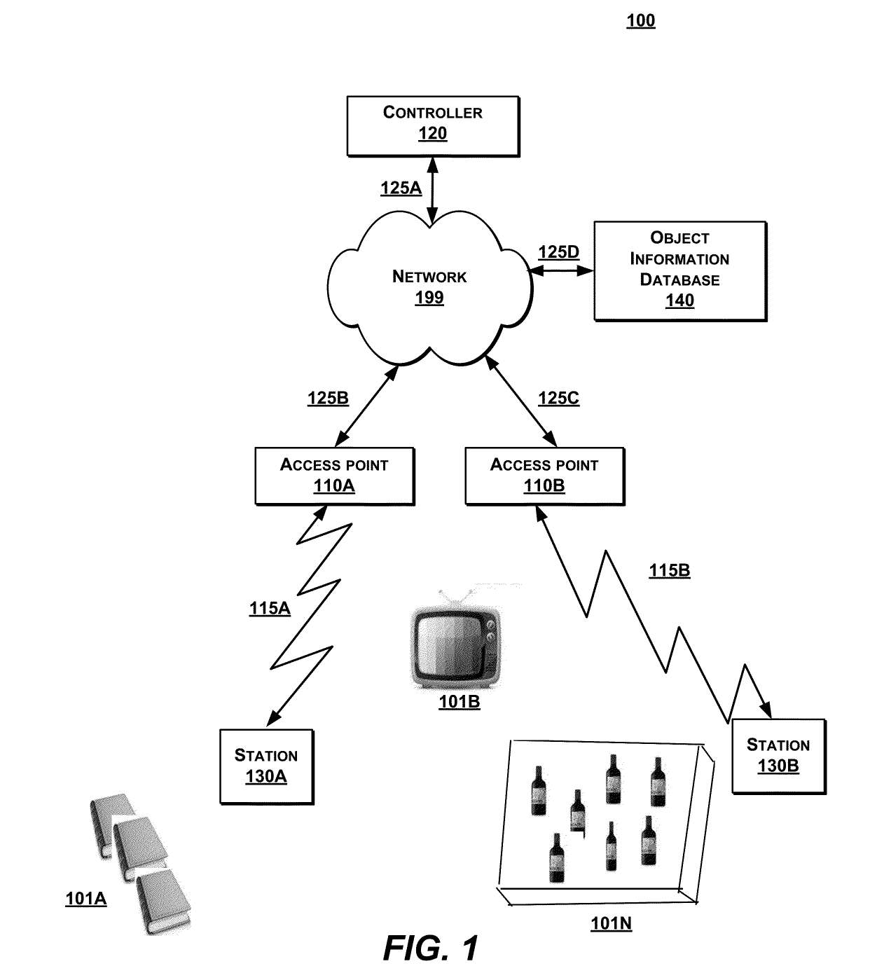

Systems to Advertise the Presence of Nearby Physical Objects within Wireless Beacons (FIGS. 1-4)

FIG. 1 is a high-level block diagram illustrating a system 100 to advertise the presence of nearby physical objects within beacons, according to one embodiment. The system 100 comprises access points 110A,B, a controller 120, (wireless) stations 130A,B, and an object information database 140. The components can be coupled to a network 199, such as the Internet, a local network or a cellular network, through any suitable wired (e.g., Ethernet) or wireless (e.g., Wi-Fi or 4G) medium, or hybrid combination of network types. In a preferred embodiment, the access points 110A,B is coupled to the stations 130A,B through wireless communication channels 115A-N. Additionally, the access points 110A,B are coupled to back-end components such as the controller 120, and coupled to and to the network 199 and external resources, such as the object information database 140 web site hosts, through wired communication channels 125A-C. Several physical objects 101A-N are configured within the system 100 for presence advertising.

Other embodiments of communication channels for system 100 are possible. Additional network components can also be part of the system 100, such as additional controllers (e.g., an SDN, or software-defined networking, controller), additional access points or only one access point, firewalls, virus scanners, routers, switches, application servers, databases, and the like. Numerous hot spots can overlap in coverage areas, operating jointly or autonomously. Moreover, an enterprise can also operate hot spots at different locations under centralized information servers.

The access points 110A,B advertise the presence of nearby physical objects to the stations 130A,B with access point beacons (e.g., a set of books 101A, a television 101 B, a case of wine 101 N, or the like). In response to detecting a location of a station, an access point searches a database (local or remote database) for nearby physical objects that have been configured with the system 100. In one embodiment, station location is defined by a radio range of an access point, so all objects are considered to be nearby for any station that receives the advertisement. In another embodiment, station location can be determined by RSSI strength with respect to a single access point or by triangulation of RSSI strength with respect to multiple access points. In yet other embodiments, station location can be determined by IP address, deep packet inspection, user input, history, or any other direct or indirect indication. The physical objects 101A-N can be manually configured locally to an access point or centrally to the controller 120. Input can be received from a hand-held scanner carried by a network administrator. Computerized physical objects can automatically self-register.

The access points 110A,B can rely upon rules, policies, preferences, and/or algorithms (referred to collectively herein as “rules”) to determine which physical objects should be advertised to which stations. The rules can rudimentarily advertise all physical objects to all stations continually for smaller systems. However, for better scalability and less spam, presence advertisements can be more narrowly tailored. For example, a PPC (Pay-Per-Click) advertising campaign can be implemented by rules defining a user or a type of station for advertising. In more detail, an avid bicyclist can be alerted as to nearby bicycling equipment while shopping at Walmart. Furthermore, the rules can set time limits on how long a presence is advertised, require a certain proximity or time of day, and can remove advertisements for physical objects that have already been acknowledged at a station. An algorithm can use local rules for an access point, remote rules from the controller 130, or a combination of both. One of ordinary skill in the art will recognize that numerous variations of rules are possible.

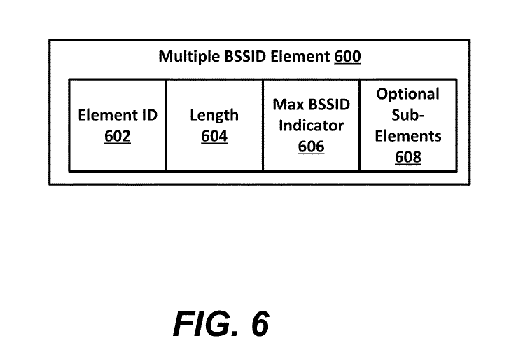

The access points 110A,B can embed pseudo-MAC addresses corresponding to physical objects as BSSIDs (Basic Service Set Identifications) and as SSIDs (Service Set Identifications) in IEEE 802.11 packets (as promulgated by the Institute of Electrical and Electronics Engineers) , or as SSIDs (Service Set Identifications). In one embodiment, beacons comprise mBeacons or meruBeacons by Meru Networks of Sunnyvale, Calif. A BSSID can be a 48-bit field of the same format as an IEEE 802 MAC address that uniquely identifies a BSS (Basic Service Set). The MAC addresses serve as globally or at least locally unique identifiers. By configuring the MAC addresses with certain markers (e.g., first 4 characters uniform for all physical objects), those MAC addresses concerning nearby physical objects can be automatically identified. The access points 110A,B broadcast beacons that can be received by any station in the area, so the presence advertising can involve any of connected stations, unassociated stations, or unauthenticated stations. In one embodiment, a separate beacon is periodically broadcast with a BSSID for each physical object. In another embodiment, an aggregate beacon is periodically broadcast with multiple BSSIDs for multiple physical objects, using protocols such as IEEE 802.11k, IEEE 802.11v and IEEE 802.11r, that support aggregate beacons. One example of a beacon format supporting aggregate BSSIDs is a Multiple BSSID element 600 of FIG. 6 for beacon or probe response frames under IEEE 802.11k, IEEE 802.11v and IEEE 802.11r. Element ID field 602 identifies the multiple BSSID value. Length 604 has a value of 1 plus the length of the extensions in units of octets. MaxBSSID Indicator 606 indicates the maximum number of BSSIDs supported, although an access point can operate with fewer. A value of n translates to 2̂n stations supported, so a value of 3 indicates that 8 BSSIs are supported. The value can be manually configured by a network administrator or automatically, for example, by a controller-based or access-point based algorithm. Optional Sub-elements 608 contains zero or more sub-elements which can be a set of BSSIDs corresponding to MAC addresses of nearby physical objects. Each of fields 602, 604 and 606 is one octet in size except the Optional Sub-elements 608 which can be of variable size. Other formats are possible.

In response to requests for additional information concerning a physical object from the stations 130A,B, the access points 110A,B can provide a description, a URL, a telephone number, a reference to the object information database 140, or any other appropriate data or pointer to data. For example, an indication of blue-ray playback capability can be provided for a nearby DVD player. The access points 110A,B can also offload responses to the object information database 140 which receives an IP address for an automatic response directly to a requestor. In alternate embodiment, the access points 110A,B broadcast standard beacons or Interwork beacons indicating that further information about nearby physical objects is available. In response, a probe request is received from each of the stations 110A,B, and the probe response can be customized for a particular station, without wasteful beacon broadcasts.

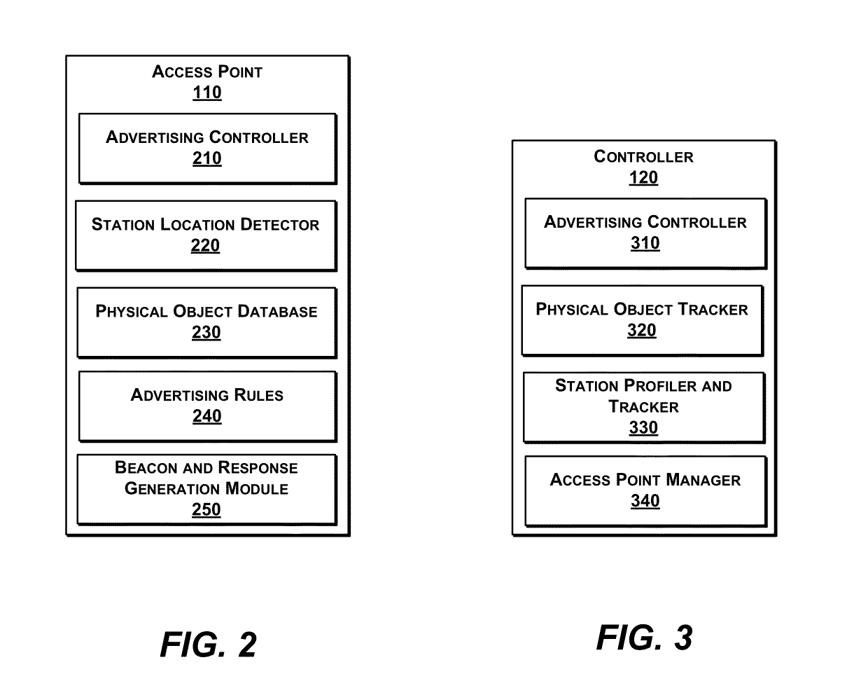

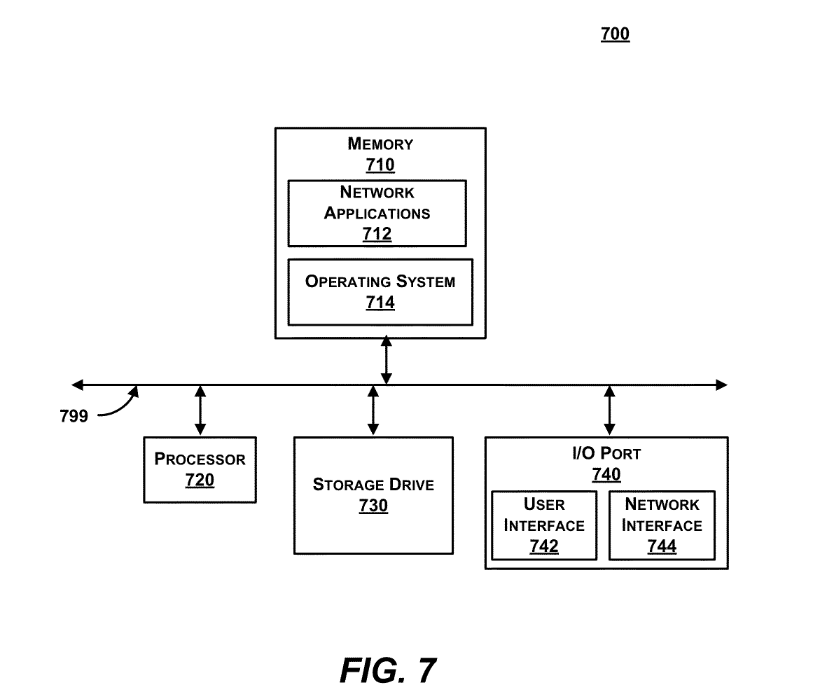

The access points 110A,B can be individually implemented as a server blade, a PC, a laptop, a smartphone with tethering services, any appropriate processor-driven device, or any of the computing devices discussed herein (e.g., see FIG. 7). The access points 110A,B can be specifically configured for object advertising or be generically configured. For example, the access points 110A,B can be an AP 110 or AP 433 (modified as discussed herein) by Meru Networks of Sunnyvale, Calif. A network administrator can strategically place the access points 110A,B for optimal coverage area over a locale. The access points 110A,B can, in turn, be connected to a wired hub, switch or router connected to the network 199. In another embodiment, the functionality is incorporated into a switch or router. More detailed embodiments of the access points 110A,B are discussed below in association with FIG. 2.

The controller 130 can manage network-wide aspects of presence advertising. In one implementation, the controller 130 tracks stations 130A,B moving among the access points 110A,B of the system 100. Having more information about characteristics of the stations 130A-N (e.g., connection history, device type, users, preferences, and display, processing and memory capabilities), the controller 130 assists in tailoring presence advertising for a particular station. In another implementation, the controller 130 tracks physical objects 101A-N moved to different locations covered by the system 100. An RFID or bar code embedded with a pseudo-MAC address can input updated locations to any of the access points 110A,B an ultimately to the controller 130. If a detected physical object has already been configured in the system 100 at a different location, that information can be updated with the new location. To do so, the controller 130 can maintain table or searchable database with pseudo-MAC addresses, object history, descriptions, and pointers for further data.

The controller 130 can be implemented in any of the computing devices discussed herein (e.g., see FIG. 9). For example, the controller 130 can be an MC1500 or MC6000 device by Meru Networks of Sunnyvale, Calif. Additional embodiments of the controller 130 are discussed with respect to FIG. 3.

The stations 130A,B detect and scan beacons from nearby access points. Scanning can be limited to an access point that a station is currently connected to, or continually for all access points within range. BSSIDs identified in beacons can be submitted to a corresponding access point (e.g., as a probe request) in order to receive further information. When a pointer to the object information database 140 or other resource is received, the stations 130A,B can automatically retrieve the information for display to a user. Example displays include advertisements, text, photos, videos, web pages, icons, logos, an SMS message, graphics or indicators within augmented reality applications, and the like.

The stations 130A,B can be individually implemented as a personal computer, a laptop computer, a tablet computer, a smart phone, a mobile computing device, a server, a cloud-based device, a virtual device, an Internet appliance, or any of the computing devices described herein (see e.g., FIG. 7). The stations 130A,B can be specifically configured for presence advertising (e.g., by downloading a mobile application) or be generically configured (e.g., with operating system integration). No special client is needed for techniques described herein, although other aspects of the network may require downloads to the stations 130A,B. The stations 130A,B connect to the access points 110A,B for access to a LAN or external networks using an RF (radio frequency) antenna and network software complying with, for example, IEEE 802.11.

FIG. 2 is a more detailed block diagram illustrating a representative access point 110 of the system 100, according to one embodiment. The access point 110 comprises an advertising controller 210, a station location detector 220, a physical object database 230, advertising rules 240, and a beacon and response generation module 250. The components can be implemented in hardware, software, or a combination of both.

The advertising controller 210 manages presence advertising in the access point 110 by calling components of the access point 110. The station location detector 220 identifies station locations from packets or SSI information passed by the advertising controller 210. The physical object database 230 stores a table or searchable records for physical objects configured for the access point 110 and is checked with respect to station locations. Additionally, the physical object database 230 responds to requests concerning particular BSSIDs or MAC addresses with data containing further information (e.g., an advertisement or a URL). The advertising rules 230 can be a database, script or XML description storing rules and can be checked by the advertising controller 210 for general rules or rules specific to MAC addresses or stations, for example. The beacon and response generation module 250 embeds BSSIDs with MAC addresses for the nearby physical objects (e.g., according to IEEE 802.11).

FIG. 3 is a more detailed block diagram illustrating the controller 120 of the system 100, according to one embodiment. The controller 120 includes an advertising controller 310, a physical object tracker 320, a station profiler and tracker 330 and an access point manager 340. The components can be implemented in hardware, software, or a combination of both.

The advertising controller 310 manages presence advertising in the controller 120 from a network-wide perspective by calling necessary components. The physical object tracker 320 matches physical objects that are moved from one location served by a first access point to another location served by a second access point using identifiers such as an RFID tag, and sends corresponding data to the second access point. The station profiler and tracker 330 identifies stations that move to from a first access point to a second access point and associates station profiles including history, device characteristics, and the like. If station location is determined by the station profiler and tracker 330, a location of the reporting access point can suffice. The access point manager 340 manages communications with multiple access points. One task of the access point manager 340 can be to assign and manage BSSIDs to access points, individual stations and individual physical objects.

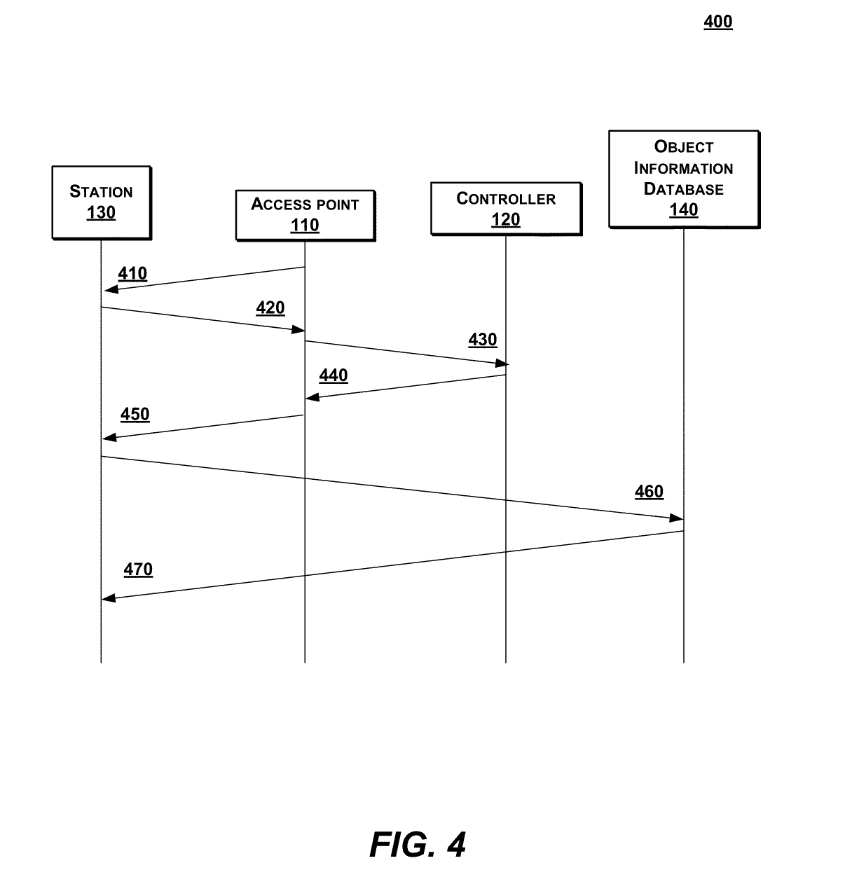

FIG. 4 is a sequence diagram illustrating interactions 400 between components of the system 100 of FIG. 1, according to one embodiment. The illustrated interactions 400 are not intended to be limiting. As such, the interactions 410 to 470 can be a portion of steps from a longer process, and separate interactions can be combined and can occur in different orders.

The access point 110 broadcasts beacons with BSSIDs for MAC addresses of nearby physical objects to station 130 and others within range (interaction 410), and the station 130 responds with a probe request seeking additional information about one of the BSSIDs, such as a product identifier that can be searched on the Internet (interaction 420). In an optional controller-centric architecture, the access point 110 sends a request to the controller 120 for a response of the additional information or information that enhances what is already stored at the access point 110 (interaction 430). The controller 120 responds with appropriate information that is forwarded to the station 130 (interaction 450). At this point, the station 130 requests information for display to a user from externally the object information database 140 (4 interaction 60) which responds to the request (interaction 470).

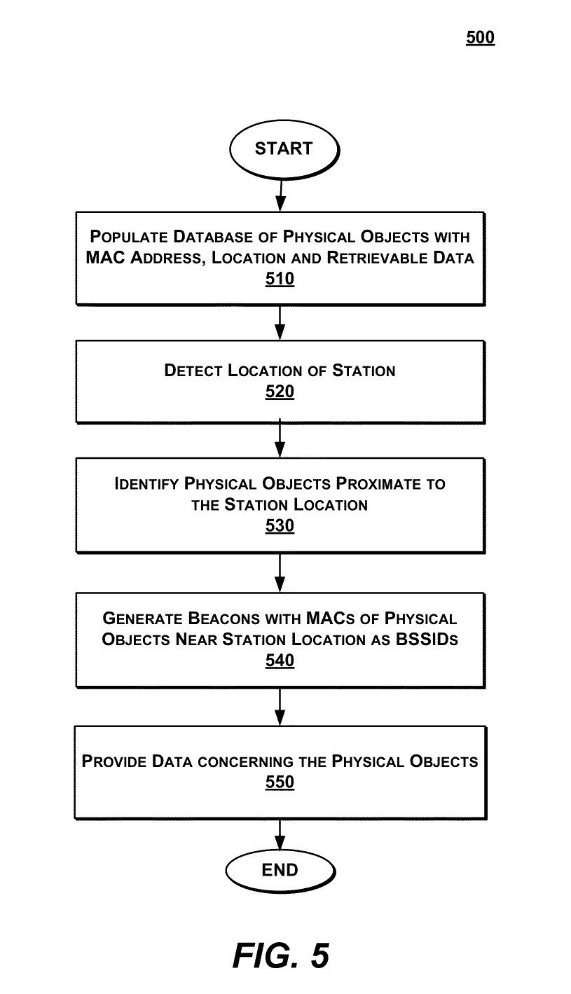

Methods for Advertising the Presence of Nearby Objects within Wireless Beacons (FIGS. 5-6)

FIG. 5 is a flow diagram illustrating a method 500 (e.g., in the access points 110A,B of FIG. 1) for advertising the presence of nearby physical objects within wireless beacons, according to one embodiment. One or ordinary skill in the art will recognize that there can be more or fewer steps than shown and the order of steps can be modified, within the scope of the present disclosure.

A database is populated on the access point 110 with MAC addresses, locations and retrievable data for physical objects (step 510). A location of a station is determined (step 520). Based on the station location, the access point 110 identifies nearby physical objects (step 530). Beacons with MACs of physical objects near the station location are generated as BSSIDs (step 540). Responsive to requests for retrievable data, the access point sends available information to the station (step 550).

FIG. 6 is a flow diagram illustrating a method 600, in the controller 120 of FIG. 1, for advertising the presence of nearby physical objects within wireless beacons, according to one embodiment.

A query for an NAI realm list is received from a station (step 610). If a record exists for a station requesting the realms, a list of most recent realms is retrieved (e.g., last N realms) (step 630), but if no record exists, a list of all supported realms is returned (step 625) and the process is not necessarily customized per-station in this instance. However, other profiling characteristics can be used for realm selection, such as device type or bandwidth needs. Various narrowing algorithms can be applied. In the present embodiment, inaccessible realms are filtered out of the list (step 640). Additional realm ranking factors can also be applied, such as preferring realms due to financial consideration or popularity (step 650).

Generic Computing Device (FIG. 7)

FIG. 7 is a block diagram illustrating an exemplary computing device 700 for use in the system 100 of FIG. 1, according to one embodiment. The computing device 700 is an exemplary device that is implementable for each of the components of the system 100, including the access points 110A,B and the stations 150A-N. The computing device 700 can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

The computing device 700, of the present embodiment, includes a memory 710, a processor 720, a storage drive 730, and an I/O port 740. Each of the components is coupled for electronic communication via a bus 799. Communication can be digital and/or analog, and use any suitable protocol.

The memory 710 further comprises network applications 712 and an operating system 714. The network applications 712 can include the modules of SDN controllers or access points as illustrated in FIGS. 2 and 3. Other network applications 712 can include a web browser, a mobile application, an application that uses networking, a remote application executing locally, a network protocol application, a network management application, a network routing application, or the like.

The operating system 714 can be one of the Microsoft Windows® family of operating systems (e.g., Windows 95, 98, Me, Windows NT, Windows 2000, Windows XP, Windows XP x64 Edition, Windows Vista, Windows CE, Windows Mobile, Windows 7 or Windows 8), Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

The processor 720 can be a network processor (e.g., optimized for IEEE 802.11), a general purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 720 can be single core, multiple core, or include more than one processing elements. The processor 720 can be disposed on silicon or any other suitable material. The processor 720 can receive and execute instructions and data stored in the memory 710 or the storage drive 730

The storage drive 730 can be any non-volatile type of storage such as a magnetic disc, EEPROM, Flash, or the like. The storage drive 730 stores code and data for applications.

The I/O port 740 further comprises a user interface 742 and a network interface 744. The user interface 742 can output to a display device and receive input from, for example, a keyboard. The network interface 744 (e.g. RF antennae) connects to a medium such as Ethernet or Wi-Fi for data input and output.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11 ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

1. A computer-implemented method in an access point for advertising the presence of nearby physical objects through a wireless portion of a communication network, the method comprising the steps of:
detecting a location of a station connected to the access point, the access point providing connectively to the communication network for the station;
identifying, from a database associated with the access point, one or more physical objects having a location proximate to the station;
responsive to the proximity of locations, at the access point, generating a beacon having a BSSID (Basic Service Set Identification) corresponding to each of the one or more physical objects, wherein the BSSID uniquely identifies each of the one or more physical objects;
transmitting the beacon to the station;
receiving, from the station, at least one of the one or more BSSIDs as unique identification for obtaining information concerning at least one of the one or more physical objects.

2. The method of claim 1, wherein the one or more physical objects have no associated computer hardware for communication with the access point or the station.

3. The method of claim 1, further comprising:
aggregating the one or more BSSIDs into a single beacon or probe response in compliance with at least one or the IEEE 802.11k, IEEE 802.11v and IEEE 802.11r protocols.

4. The method of claim 1, further comprising:
receiving a request for retrievable information for a BSSID corresponding to one of the one or more physical objects;
looking-up the retrievable information according to the BSSID; and
transmitting the retrievable information to the station.

5. The method of claim 1, wherein the retrievable information about the nearby physical object is displayed to a user of the station.

6. The method of claim 1, wherein the retrievable information is used to query an external data resource about the nearby physical object.

7. The method of claim 1, wherein detecting the location comprises:
receiving an RSSI measurement indicative of a distance between the station and the access point.

8. The method of claim 1, wherein the BSSID includes markers to indicate to the station that the BSSID concerns a nearby physical object.

9. A non-transitory computer readable medium storing source code that, when executed by a computer, performs a method in an access point for advertising the presence of nearby physical objects through a wireless communication network, the method comprising the steps of:
detecting a location of a station connected to the access point, the access point providing connectively to the communication network for the station;
identifying, from a database associated with the access point, one or more physical objects having a location proximate to the station;
responsive to the proximity of locations, at the access point, generating a beacon having a BSSID (Basic Service Set Identification) corresponding to each of the one or more physical objects, wherein the BSSID uniquely identifies each of the one or more physical objects;
transmitting the beacon to the station, wherein the station submits
receiving, from the station, at least one of the one or more BSSIDs as unique identification for obtaining information concerning at least one of the one or more physical objects.

10. The computer readable medium of claim 9, wherein in the method, the one or more physical objects have no associated computer hardware for communication with the access point or the station.

11. The computer readable medium of claim 9, the method further comprising:
aggregating the one or more BSSIDs into a single beacon or probe response in compliance with at least one or the IEEE 802.11k, IEEE 802.11v and IEEE 802.11r protocols.

12. The computer readable medium of claim 9, the method further comprising:
receiving a request for retrievable information for a BSSID corresponding to one of the one or more physical objects;
looking-up the retrievable information according to the BSSID; and
transmitting the retrievable information to the station.

13. The computer readable medium of claim 9, wherein in the method, the retrievable information about the nearby physical object is displayed to a user of the station.

14. The computer readable medium of claim 9, wherein in the method, the retrievable information is used to query an external data resource about the nearby physical object.

15. The computer readable medium of claim 9, wherein in the method, the detecting the location comprises:
receiving an RSSI measurement indicative of a distance between the station and the access point.

16. The computer readable medium of claim 9, wherein in the method, the BSSID includes markers to indicate to the station that the BSSID concerns a nearby physical object.

17. An access point for advertising the presence of nearby physical objects through a wireless communication network, the access point comprising:
a processor; and
a memory, comprising:
a first module to detect a location of a station connected to the access point, the access point providing connectively to the communication network for the station;
a second module to identify, from a database associated with the access point, one or more physical objects having a location proximate to the station;
a third module to, responsive to the proximity of locations, at the access point, generate a beacon having a BSSID (Basic Service Set Identification) corresponding to each of the one or more physical objects, wherein the BSSID uniquely identifies each of the one or more physical objects;
a fourth module to transmit the beacon to the station; and
a fifth module to receive, from the station, at least one of the one or more BSSIDs as unique identifiers for obtaining information concerning the one or more physical objects.
